(19) United States
(12) Patent Application Publication
(10) Pub. No.: US 2008/0043650 A1
(43) Pub. Date: Feb. 21, 2008

(54) APPARATUS AND METHOD FOR TRANSMITTING AND RECEIVING FRAME IN BROADBAND WIRELESS ACCESS SYSTEM

(75) Inventors: Jae-Hyuk Jang, Suwon-si (KR); Jung-Je Son, Seongnam-si (KR); Nam-Gi Kim, Suwon-si (KR); Min-Hee Cho, Suwon-si (KR)

Correspondence Address: Jefferson IP Law, LLP, 1730 M Street, NW, Suite 807, Washington, DC, 20036, US

(73) Assignee: SAMSUNG ELECTRONICS CO., LTD., Suwon-city (KR)

(21) Appl. No.: 11/840,368

(22) Filed: Aug. 17, 2007

(30) Foreign Application Priority Data
Aug. 17, 2006 (KR) 2006-0077441

(51) Int. Cl. H04B 7/00

(52) U.S. Cl. 370/310

(57) ABSTRACT

An apparatus and method for transmitting and receiving a frame in a Broadband Wireless Access (BWA) system are provided. In the BWA system for transmitting and receiving a super frame including one or more sub-frames, a base station includes a first generator for generating resource allocation information on a circuit service and a transmitter for transmitting the resource allocation information provided from the first generator in a first part of the super frame. Accordingly, for a service (e.g., VoIP service) in which resources have to be periodically allocated, resource allocation information is transmitted during each main period (i.e., super frame), and thus there is an advantage in that the size of control information can be significantly reduced.

### PRIORITY

This application claims the benefit under 35 U.S.C. § 119(a) of a Korean patent application filed in the Korean Intellectual Property Office on Aug. 17, 2007 and assigned Serial No. 2006-0077441, the entire disclosure of which is hereby incorporated by reference.

### BACKGROUND OF THE INVENTION

1. Field of the Invention

The present invention relates to an apparatus and method for transmitting and receiving a frame in a broadband wireless access system. More particularly, the present invention relates to an apparatus and method for transmitting and receiving a frame with a structure supporting a circuit mode.

2. Description of the Related Art

Today, many wireless communication techniques are being proposed to achieve a high-speed mobile communication. Among them, an Orthogonal Frequency Division Multiplexing (OFDM) scheme is accepted as one of the most promising techniques for a next generation wireless communication. The OFDM scheme is expected to be widely used in the 4^{th} Generation (4G) wireless communication technique, and is currently used as a standard in the Institute of Electrical and Electronics Engineers (IEEE) 802.16 based Wireless Metropolitan Area Network (WMAN) known as the 3.5G technology, which standard is hereby incorporated by reference.

The IEEE 802.16d and the IEEE 802.16e are examples of a wireless communication standard of the IEEE 802.16 working group. The IEEE 802.16d and the IEEE 802.16e are classified into a Single Carrier standard, an OFDM standard and an Orthogonal Frequency Division Multiple Access (OFDMA) standard.

In order to facilitate flexible allocation of Uplink (UL)/Downlink (DL) resources in an OFDM based Broadband Wireless Access (BWA) system, a Base Station (BS) transmits UL/DL resource allocation information for each frame. For this purpose, a MAP message is used in an IEEE 802.16 based system.

FIG. 1 illustrates a conventional frame structure used in an IEEE 802.16 based system.

Referring to FIG. 1, a frame includes one DL frame and one UL frame. The DL frame is defined as a period in which a Base Station (BS) transmits data to a plurality of Mobile Stations (MSs). The UL frame is defined as a period in which the MSs located in a region transmit data to the BS.

The DL frame includes a preamble, a Frame Control Header (FCH), a DL MAP, an UL MAP and a plurality of DL data bursts. In addition, the UL frame includes a control region and an UL data burst region. The DL preamble is used when the MS obtains initial synchronization and searches for a cell. The FCH contains information indicating a basic structure of the frame. The DL MAP contains Information Elements (IEs) for indicating DL data burst regions. The UL MAP contains IEs for indicating an UL frame structure.

The control region of the UL frame includes a ranging region, a Channel Quality Indicator Channel (CQICH) region, an Acknowledgement Channel (ACKCH) region and a sounding region. The ranging region is defined as a region in which an MS can transmit a code without a BS assigned for the MS. The ranging region is used to perform an initial network access, to request a handoff, to request resource allocation, and so on. The CQICH region is used when the MS reports a DL channel condition. The ACKCH region is used to report whether a DL data burst has been successfully received. The sounding region is used to transmit a sounding signal for estimating an UL channel.

In general, the frame structure is determined by the BS. For each frame, the MS receives the DL MAP and the UL MAP transmitted from the BS, and thus recognizes the frame structure and allocation information.

In a conceptual (or logical) frequency domain and a time domain of FIG. 1, data is represented by using a sub-channel and an OFDM symbol. A basic unit of data that can be transmitted to one user includes one sub-channel and one OFDM symbol. A vertical axis represents a sub-channel that is a unit of frequency resource allocation, wherein one frame includes L+1 sub-channels from s to s+L. A horizontal axis represents an index of an OFDM symbol that is a unit of time resource allocation, wherein one frame includes M+1 DL OFDM symbols from k to k+M and N UL OFDM symbols from k+M+1 to k+M+N. As a guard region, a Transmit/receive Transition Gap (TTG) exists between the DL frame and the UL frame.

As described above, in the OFDM based BWA system, a DL burst and an UL burst in a frame can be allocated to at least one sub-channel and one OFDM symbol, and thus the frame structure can be flexibly formed with a minimum restriction. However, to minimize the restriction in the forming the frame structure, the size of control information to be transmitted increases. Thus, when one frame includes data of multi-users, the control information, which is reported to the users by using the DL-MAP and UL-MAP, becomes a serious overhead.

In particular, when using of a service (e.g., Voice over Internet Protocol (VoIP) service) requires periodic transmission of packets, waste of resource may result if a BS allocates resources by using a resource allocation message (e.g., DL-MAP and UL-MAP) whenever required. Therefore, there is a need for a new method for allocating resources as well as a corresponding new frame structure.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for reducing a size of control information in a Broadband Wireless Access (BWA) system.

Another aspect of the present invention is to provide a frame structure for supporting a circuit mode in a BWA system.

Another aspect of the present invention is to provide an apparatus and method for transmitting and receiving a frame with a structure which supports a circuit mode in a BWA system.

Another aspect of the present invention is to provide an apparatus and method for allocating resources for circuit communication in a BWA system.

According to one aspect of the present invention, a base station apparatus in a BWA system for transmitting and receiving a super frame including one or more sub-frames is provided. The apparatus comprises a first generator for generating resource allocation information on a circuit service, and a transmitter for transmitting the resource allocation information provided from the first generator in a first part of the super frame.

According to another aspect of the present invention, a mobile station apparatus in a BWA system for transmitting and receiving a super frame including one or more sub-frames is provided. The apparatus comprises a receiver for restoring a signal, received from a base station, into a packet, and a first analyzer for analyzing the packet received from a first part of the super frame so as to obtain resource allocation information on a circuit service.

According to another aspect of the present invention, a communication method of a base station in a BWA system for transmitting and receiving a super frame including one or more sub-frames is provided. The method comprises generating resource allocation information on a circuit service, transmitting the resource allocation information provided from the first generator in a first part of the super frame, generating relative resource allocation information on an updated resource when the resource for the circuit service is updated in the current sub-frame, and transmitting the relative resource allocation information using a control region of the current sub-frame.

According to another aspect of the present invention, a communication method of a mobile station in a BWA system for transmitting and receiving a super frame including one or more sub-frames is provided. The method comprises restoring a signal, received from a base station, into a packet, analyzing the packet received from a first part of the super frame so as to obtain resource allocation information on a circuit service, and obtaining relative resource allocation information indicating resource update information for the circuit service by analyzing a packet received using a control region of the sub-frame.

According to another aspect of the present invention, a method of a wireless communication system for transmitting and receiving a super frame including one or more sub-frames is provided. The method comprises constructing a control region for transmitting resource allocation information on a circuit service in a first part of the super frame, and if a resource for the circuit service has been updated, constructing a region for transmitting relative resource allocation information on the updated resource in a corresponding sub-frame.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 illustrates a conventional frame structure used in a system based on the Institute of Electrical and Electronics Engineers (IEEE) 802.16;

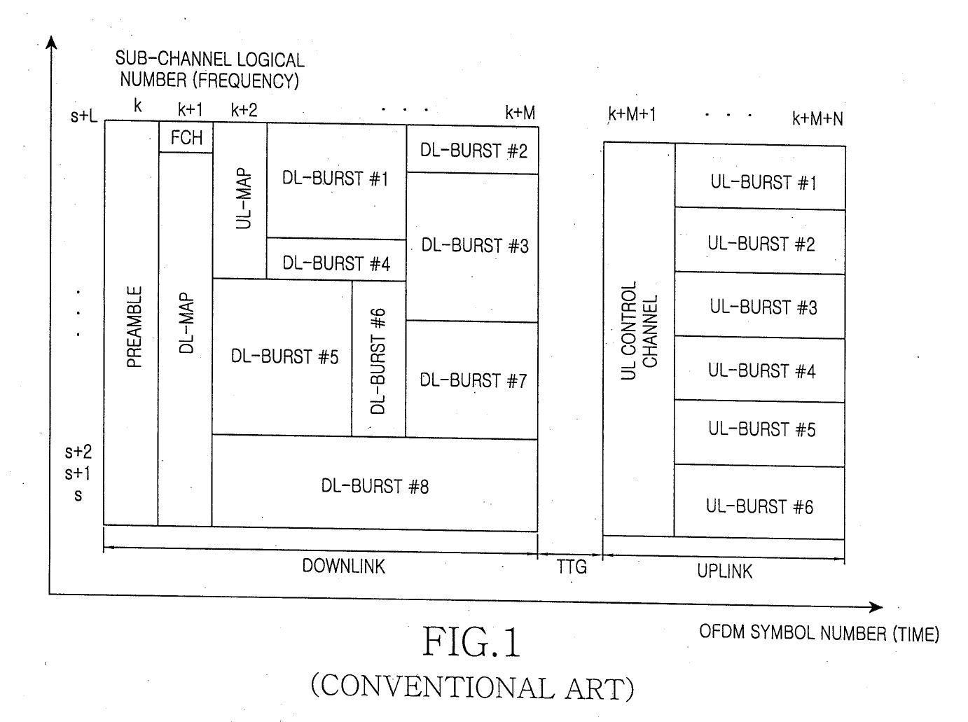

FIG. 2 illustrates a frame structure according to an exemplary embodiment of the present invention;

FIG. 3 is a block diagram of a Base Station (BS) in a Broadband Wireless Access (BWA) system according to an exemplary embodiment of the present invention;

FIG. 4 is a block diagram of a Mobile Station (MS) in a BWA system according to an exemplary embodiment of the present invention;

FIG. 5 is a flowchart illustrating an operation of a BS in a BWA system according to an exemplary embodiment of the present invention; and

FIG. 6 is a flowchart illustrating an operation of an MS in a BWA system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

Hereinafter, a frame structure supporting a circuit mode and an apparatus and method for transmitting and receiving a frame with that frame structure in a Broadband Wireless Access (BWA) system will be described as an exemplary implementation.

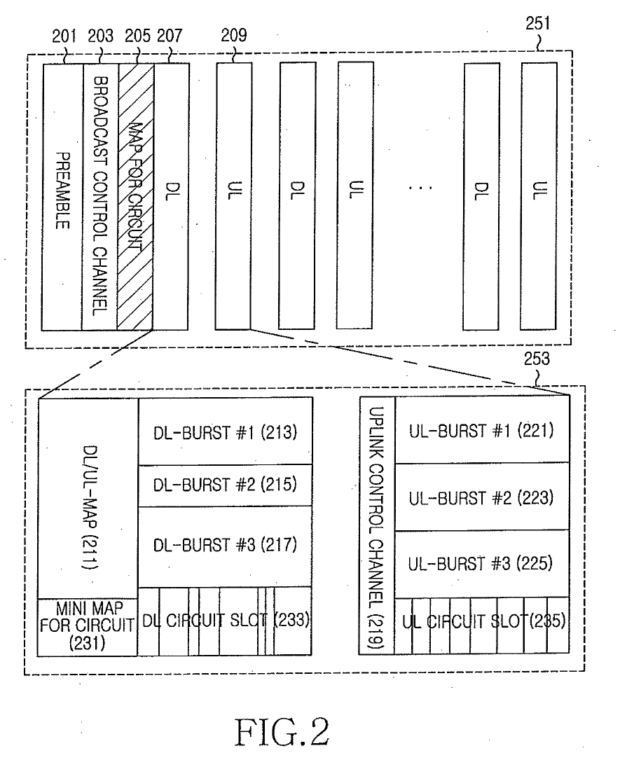

FIG. 2 illustrates a frame structure according to an exemplary embodiment of the present invention.

Referring to FIG. 2, a super frame (or multi frame) 251 includes a plurality of frames 253 each having a length (e.g., 5 msec). The frame 253 is divided into a Downlink (DL) frame 207 and an Uplink (UL) frame 209. Control regions 201, 203 and 205 are located in a first part of the super frame 251. The control regions may be a preamble 201, a broadcast control channel 203, and a circuit control channel 205. Herein, it will be assumed that a period for transmitting the control regions is 5 msec and a total period of the super frame 251 is 205 msec. In this case, one super frame 251 may include 40 frames each having a length of 5 msec.

The preamble 201 is used to transmit a preamble signal so as to provide synchronization to Mobile Stations (MSs) newly connected to the network. The broadcast control channel 203 is used to transmit parameters for operating the MSs and paging information. Examples of the parameters include an Uplink Channel Descriptor (UCD) and a Downlink Channel Descriptor (DCD). The circuit control channel 205 is used to transmit absolute resource allocation information (e.g., MAP information) for the MSs which receive a circuit service. The resource allocation information (or resource allocation message) transmitted using the circuit control channel 205 will be described in detail with reference to Table 1 below.

The structure of a 5 msec frame will now be described. The frame structure is similar to the Institute of Electrical and Electronics Engineers (IEEE) 802.16e frame structure except that a preamble and a Frame Control Header (FCH) are excluded. A DL control region 211 is located in a first part of the DL frame 207 and is used to transmit resource allocation information (e.g., DL/UL-MAP) for UL and DL transmission. Herein, the resource allocation information may contain relative resource allocation information, i.e., Mini MAP for circuit, for the MSs which receive the circuit service. The relative resource allocation information will be described in detail with reference to Table 2 below.

The DL frame 207 includes regions 213, 215 and 217 for a plurality of DL bursts DL-Burst #1 to DL-Burst #N and a DL circuit slot 233 for the circuit service. Although a general data burst and a data burst for the circuit service are distinctively allocated to different regions in the figure, this is exemplary. Thus, in exemplary implementation, two types of data bursts may be allocated to the same region without distinction. In addition, although the data bursts (or packets) for the circuit service are sequentially allocated in a 1-dimensional manner in the figure, they may be allocated in a 2-dimensional manner similar to the case of the general data bursts.

A UL control channel 219 is located in a first part of the UL frame 209 and is used to transmit an UL control signal from the MSs to a Base Station (BS). Further, the UL control channel 219 includes regions 221, 223 and 225 for a plurality of UL bursts UL-Burst #1 to UL-Burst #N and a UL circuit slot 235 for the circuit service. Although a general data burst and a data burst for the circuit service are distinctively allocated to different regions in the figure, this is exemplary. Thus, in exemplary implementation, two types of data bursts may be allocated to the same region without distinction. In addition, although the data bursts (or packets) for a circuit service are sequentially allocated in a 1-dimensional manner in the figure, they may be allocated in a 2-dimensional manner similar to the case of the general data bursts.

In the aforementioned frame structure, the circuit control channel 205 is used to transmit absolute resource allocation information on the MSs which receives the circuit service. The resource allocation information (e.g., MAP information) transmitted by using the circuit control channel 206 is described in Table 1 below.

TABLE 1

| | |
|---|---|
| MAP_for_circuit_format ( ) { | |
| number of circuit frame (N) | 4 bits |
| Reserved | 4 bits |
| for (i=1; i<=N; i++) { | |
| number of downlink user (D) | 8 bits |
| for (j=1; j<=D; j++) | |
| user id | a bits |
| modulation and coding | b bits |
| resource allocation info | c bits |
| (HARQ info, CQICH allocation info) | d bits |
| } | |
| number of uplink user (U) | 8 bits |
| for (k=1; k<=U; k++) | |
| user id | a bits |
| modulation and coding scheme | b bits |
| resource allocation info | c bits |
| (HARQ info, CQICH allocation info) | d bits |
| } | |
| } | |
| } | |

Referring to Table 1, a resource allocation message for allocating absolute resources to the MSs which receive the circuit service contains the number of circuit frames included in a super frame, information on DL users and information on UL users. The information on the DL users may contain a user ID, a modulation and coding scheme, resource allocation information and control information (e.g., HARQ information and CQICH allocation information). The information on the UL users may contain a user ID, a modulation and coding scheme, resource allocation information and control information (HARQ information and CQICH allocation information).

The number of circuit frames matches to a circuit resource allocation period. For example, when using a VoIP service, a packet generation period is 20 msec, and thus resources are allocated for every 20 msec. In this case, the number of circuit frames is 4 (0b0100), and this means that absolute circuit service resources are allocated to the four frames. The user ID is an absolute ID, for example, a basic Connection Identifier (CID). The modulation and coding scheme represents a Modulation and Coding Scheme (MCS) level applied to a corresponding data burst (or packet). The resource allocation information is absolute information on allocated resources (e.g., start point, size, etc.).

The absolute resource allocated using the circuit control channel 205 is maintained for the period of the super frame as long as update is not necessary. However, when an MS channel condition changes, or when a call is temporarily stopped or released, or when a new user is added, resource allocation has to be performed again. As such, in the case where a resource pre-allocated to the circuit service is updated, the updated resource has to be reported to the MS. Thus, the BS reports the MS of the updated resource by using the DL control region 211 of the 5 msec frame 253. The relative resource allocation information, which is provided for the circuit service and is transmitted using the DL control region 211, is described in Table 2 below.

TABLE 2

| | | |
|---|---|---|
| Mini_MAP_for_circuit_format ( ) { | | |
| number of deleted downlink user (DD) | 8 | bits |
| for (i=1; i<=DD; i++) { | | |
| (relative) user id | x or a | bits |
| } | | |
| number of updated downlink user (DU) | 8 | bits |
| for (j=1; j<=DU; j++) { | | |
| (relative) user id | x or a | bits |
| plus/minus indicator | 1 | bits |
| relative resource allocation info | y | bits |
| (HARQ info, CQICH allocation info) | d | bits |
| } | | |
| number of added downlink user (DA) | 8 | bits |
| for (k=1; k<=DA; k++) { | | |
| user id | a | bits |
| modulation and coding | b | bits |
| resource allocation info | c | bits |
| (HARQ info, CQICH allocation info) | d | bits |
| } | | |
| number of deleted uplink user (UD) | 8 | bits |
| for (i=1; i<=UD; i++) { | | |
| (relative) user id | x or a | bits |
| } | | |
| number of updated uplink user (UU) | 8 | bits |
| for (j=1; j<=UU; j++) { | | |
| (relative) user id | x or a | bits |
| plus/minus indicator | 1 | bits |
| relative resource allocation info | y | bits |
| (HARQ info, CQICH allocation info) | d | bits |
| } | | |
| number of added uplink user (UA) | 8 | bits |
| for (k=1; k<=UA; k++) { | | |
| user id | a | bits |
| modulation and coding | b | bits |
| resource allocation info | c | bits |
| (HARQ info, CQICH allocation info) | d | bits |
| } | | |
| } | | |

Referring to Table 2, the relative resource allocation information can be divided into UL link information and DL information. The DL information contains information on a user whose DL resource is released in the current frame, information on a user whose DL resource is updated in the current frame, and information on a user to whom a new resource is allocated in the current frame. Likewise, the UL information contains information on a user whose UL resource is released in the current frame, information on a user whose UL resource is updated in the current frame, and information on a user to whom a new resource is allocated in the current frame.

For a user ID for the user whose UL resource is released in the current frame and a user ID of the user whose UL resource is updated in the current frame, the absolute ID described in Table 1 or the relative ID determined in the order of resource allocation may be used. The user ID may be reported using the broadcast control channel 203 of FIG. 2 or may be defined as a system parameter. When using the relative ID, circuit users need to update the relative IDs whenever a circuit resource allocated to a user is released.

The information on the user whose resource is updated in the current frame may contain a user ID, a plus/minus indicator, a resource increment or decrement rate and additional information. The plus/minus indicator is 1-bit flag information indicating whether a resource increases or decreases, and the resource increment or decrement rate is information indicating an amount of the resource increased or decreased.

The information on the user to whom a new resource is allocated in the current frame may contain a user ID, an MCS level, resource allocation information and additional information (e.g., HARQ information, CQICH allocation information, etc.).

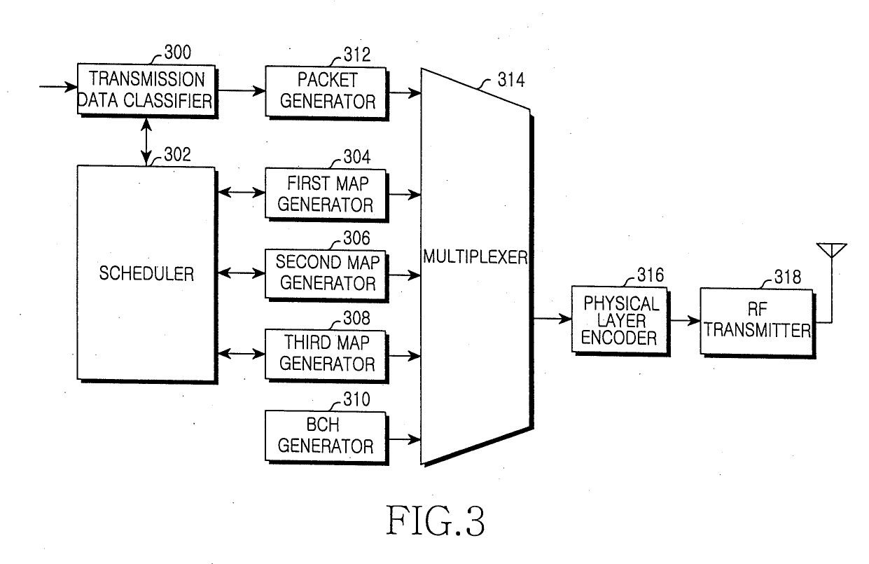

FIG. 3 is a block diagram of a BS in a BWA system according to an exemplary embodiment of the present invention.

Referring to FIG. 3, the BS includes a transmission data classifier 300, a scheduler 302, a first MAP generator 304, a second MAP generator 306, a third MAP generator 308, a Broadcast Channel (BCH) generator 310, a packet generator 312, a multiplexer 314, a physical layer encoder 316 and a Radio Frequency (RF) transmitter 318.

The transmission data classifier 300 classifies transmission data (or service packet) according to data type, and buffers the classified data to be output. The scheduler 302 schedules resources for the transmission data loaded in the transmission data classifier 300 and outputs the scheduling result to the MAP generators 304, 306 and 308.

The first MAP generator 304 generates absolute resource allocation information (see Table 1) regarding users receiving a circuit service and is transmitted using the circuit control channel 205 included in the control region of the super frame 251. The second MAP generator 306 generates MAP information (or resource allocation information) transmitted using the DL control region 211 included in the 5 msec frame 253. The MAP information generated by the second MAP generator 306 is not related to the circuit service. When a resource pre-allocated to a service is updated, the third MAP generator 308 generates resource allocation information on the updated resource. Herein, the resource allocation information on the updated resource is transmitted using the DL control region 211.

The BCH generator 310 generates broadcast control information transmitted using the broadcast control channel 203 included in the control regions of the super frame 251. The packet generator 312 generates a specific packet (e.g., Medium Access Control (MAC)-Protocol Data Unit (PDU)) using data transmitted from the transmission data classifier 300 in response to the scheduling result.

According to a predetermined rule, the multiplexer 314 selects packets transmitted from the packet generator 312, the first MAP generator 304, the second MAP generator 306, the third MAP generator 308 and the BCH generator 310. For example, when a super frame starts, the multiplexer 314 selects an output of the BCH generator 310, and then selects an output of the first MAP generator 304. Thereafter, the multiplexer 314 selects an output of the second MAP generator 306 and an output of the third MAP generator 308 in a first part of the 5 msec frame, and selects packets transmitted from the packet generator 312 at the DL frame period.

When the super frame starts, the physical layer encoder 316 generates a preamble which is first received from the super frame, and then outputs packets transmitted from the multiplexer 314 by encoding the packets in a physical layer. The physical layer encoder 316 may include a channel coding block, a modulation block, and so on. In the case of using an OFDM system, the channel coding block may include a channel encoder, an interleaver and a modulator. In addition, the modulation block may include an Inverse Fast Fourier Transform (IFFT) operator for transmitting data on a plurality of orthogonal sub-carriers.

The RF transmitter 318 converts a baseband digital signal received from the BCH generator 310 into an analog signal, converts the baseband analog signal into an RF signal, and transmits the converted signals through an antenna. The structure of the BS of FIG. 3 is illustrated on a transmission function only, while omitting a receiving function.

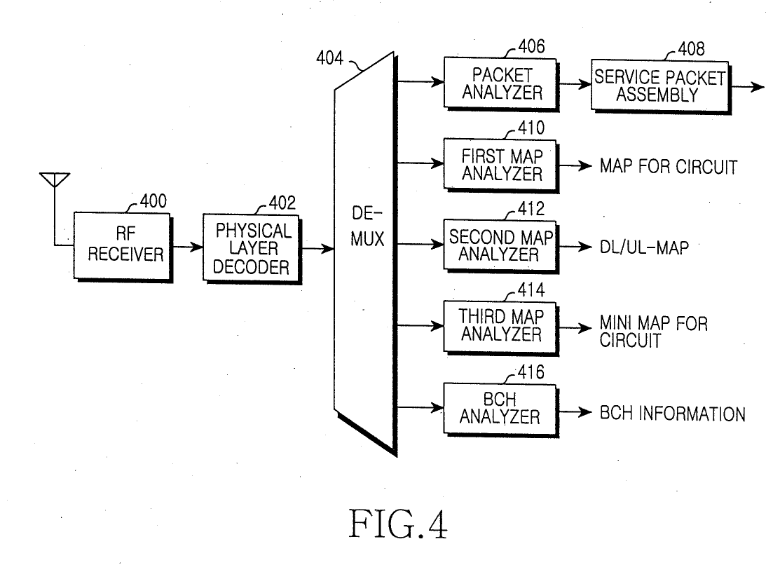

FIG. 4 is a block diagram of an MS in a BWA system according to an exemplary embodiment of the present invention.

Referring to FIG. 4, the MS includes an RF receiver 400, a physical layer decoder 402, a de-multiplexer 404, a packet analyzer 406, a service packet assembly 408, a first MAP analyzer 410, a second MAP analyzer 412, a third MAP analyzer 414 and a BCH analyzer 416.

The RF receiver 400 converts an RF signal received through an antenna into a baseband signal, and converts the baseband analog signal into a digital signal.

When a super frame starts, the physical layer decoder 402 obtains synchronization by using a preamble signal which is first received from the super frame. Thereafter, the physical layer decoder 402 decodes a digital signal received from the RF receiver 400 and delivers corresponding packets to the de-multiplexer 404. The physical layer decoder 402 may include a modulation block, a channel decoding block, and so on. In the case of using the OFDM system, the modulation block may include an FFT operator for extracting data carried on each sub-carrier. In addition, the channel decoding block may include a demodulator, a de-interleaver and a channel decoder.

The de-multiplexer 404 classifies the packets received from the physical layer decoder 402 according to a predetermined rule, and then provides the packets to a corresponding analyzer. First, the de-multiplexer 404 provides packets received using the broadcast control channel included in the super frame to the BCH analyzer 416. Then, the BCH analyzer 416 analyzes the packets received from the de-multiplexer 404, thereby obtaining broadcast control information (e.g., UCD/DCD).

Next, the de-multiplexer 404 provides packets received using the circuit control channel 205 included in the super frame to the first MAP analyzer 410. Then, the first MAP analyzer 410 analyzes the packets received from the de-multiplexer 404 and thus obtains resource allocation information on a circuit service to which resources are periodically allocated during the super frame period.

Next, the de-multiplexer 404 provides packets received using the DL control region for each 5 msec frame to the second MAP analyzer 412. Then, the second MAP analyzer 412 analyzes the packets received from the de-multiplexer 404 and thus obtains resource allocation information regarding DL bursts and UL bursts in the 5 msec frame. In addition, when resource allocation messages (e.g., MAP IEs) for the circuit service are detected, the second MAP analyzer 412 provides the detected messages to the third MAP analyzer 414. Then, the third MAP analyzer 414 analyzes the resource allocation messages received from the second MAP analyzer 412, and thus obtains resource update information regarding the pre-allocated circuit service. The MS uses the obtained resource allocation information and resource update information and then determines a resource for receiving DL data and a resource for transmitting UL data.

Next, for each 5 msec frame, the de-multiplexer 404 provides data packets received during a DL frame to the packet analyzer 406. Then, the packet analyzer 406 performs an error detection operation on the packets received from the de-multiplexer 404, and outputs a payload after removing its header. The service packet assembly 408 assembles a service packet (e.g., service data unit) by using the payload received from the packet analyzer 406. The service packet is then processed in an upper layer (e.g., application layer).

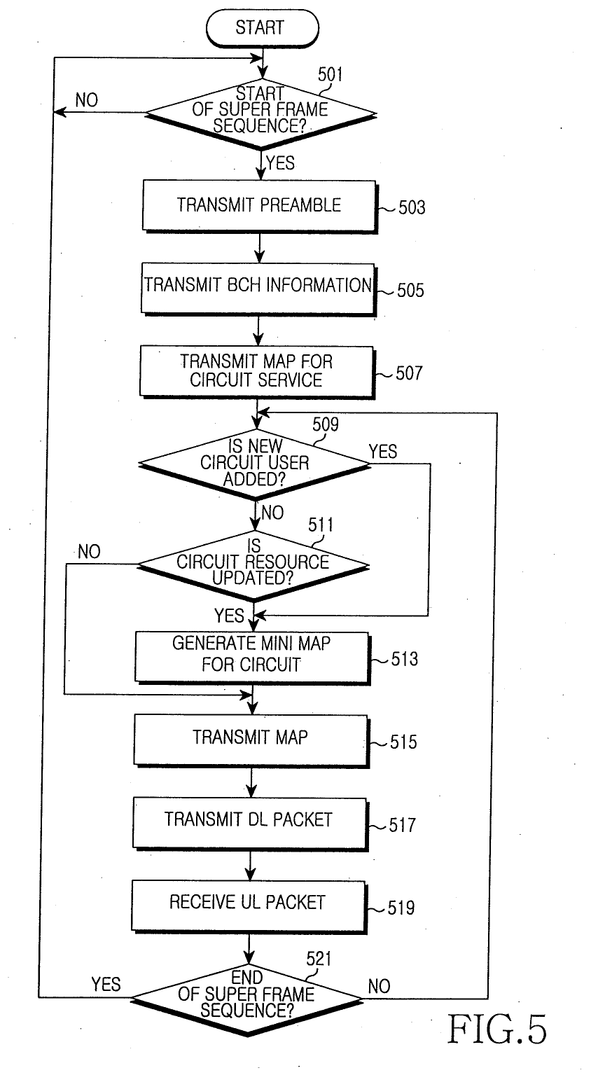

FIG. 5 is a flowchart illustrating an operation of a BS in a BWA system according to an exemplary embodiment of the present invention.

Referring to FIG. 5, in step 501, it is determined whether a super frame sequence starts. When the super frame sequence starts, in step 503 a preamble signal for providing synchronization to a plurality of MSs is transmitted in a first part of the super frame.

In step 505, BCH information is transmitted subsequent to the transmission of the preamble signal. In step 507, absolute resource allocation information on a circuit service is transmitted subsequent to the transmission of the BCH information.

Upon completing the transmission of the control information pieces included in the first part of the super frame, in step 509, it is determined whether a new circuit user is added to a current 5 msec frame. If the new circuit user is added, in step 513, resource allocation information (Mini MAP for circuit) for the new circuit user is generated, and then the procedure proceeds to step 515.

In contrast, if the new circuit user is not added, in step 511 it is determined whether a resource pre-allocated to the circuit service is updated (or released). If the pre-allocated resource is not updated, the procedure proceeds to step 515. Otherwise, in step 513, relative resource allocation information (Mini MAP for circuit) for the updated resource is generated, and then the procedure proceeds to step 515.

In step 515, general resource allocation information (including resource allocation information on the circuit service) is generated and transmitted for the 5 msec frame. In step 517, according to the resource allocation information, DL packets are transmitted to the MSs during a DL frame of the 5 msec frame. In step 519, UL packets are received from the MSs during an UL frame of the 5 msec frame.

As such, upon completing the transmission of the 5 msec frame, in step 521, it is determined whether communication for the super frame has been finished. If the communication for the super frame is not finished, the procedure returns to step 509, and thus communication for a next 5 msec frame is resumed. In contrast, if the super frame sequence ends, the procedure returns to step 501 and the subsequent steps are repeated to resume the communication for the next super frame.

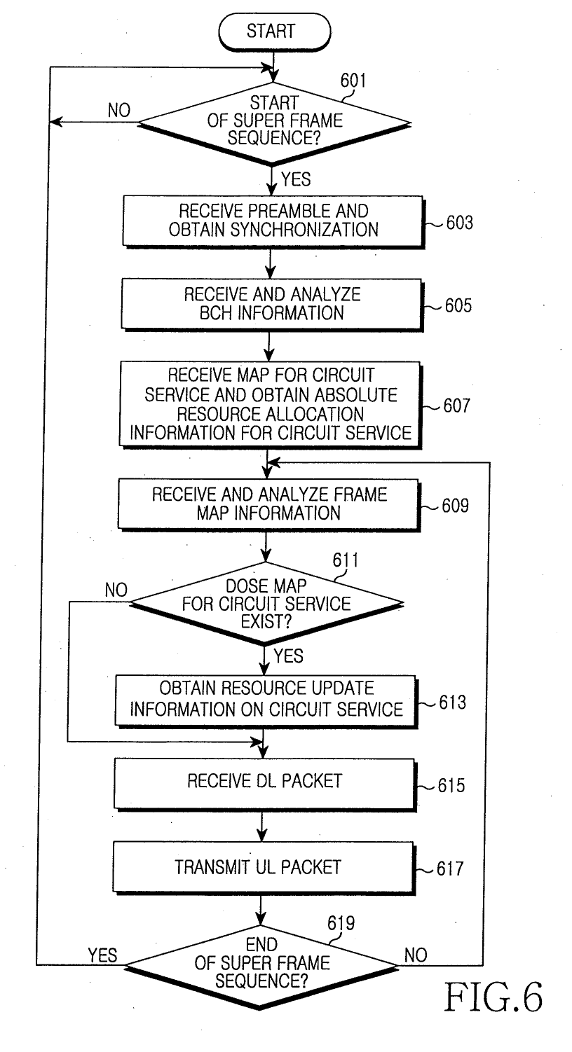

FIG. 6 is a flowchart illustrating an operation of an MS in a BWA system according to an exemplary embodiment of the present invention.

Referring to FIG. 6, in step 601, it is determined whether a super frame starts. When the super frame starts, in step 603, by using a preamble signal received in a first part of the super frame, synchronization is obtained, and a channel is estimated.

In step 605, BCH information received subsequent to the reception of the preamble signal is analyzed to obtain various pieces of broadcast control information (e.g., system parameter). In step 607, a circuit control channel received subsequent to the reception of the BCH information is analyzed to obtain absolute resource information (Mini MAP for circuit) for a circuit service maintained for the super frame period.

In step 609, resource allocation information (e.g., MAP information) is received and analyzed from a first part of the 5 msec frame. Thus, the MS can recognize a general resource allocation condition for the 5 msec frame. The MAP information received in the first part of the 5 msec frame may include resource allocation information on the circuit service (Mini MAP for circuit).

In step 611, the existence of the resource allocation information on the service is determined. If the resource allocation information on the circuit service does not exist, the procedure proceeds to step 615. Otherwise, in step 613, the resource allocation information is analyzed to recognize whether changes are detected from a resource for the circuit service (e.g., new service is added, resource for existing service is updated or released, etc.). Then, the procedure proceeds to step 615.

In step 615, according to the recognition result, DL packets are received from a BS during the DL frame of the 5 msec frame. In step 617, UL packets are transmitted to the BS during the UL frame of the 5 msec frame.

As such, upon completing the transmission of the 5 msec frame, in step 619, it is determined whether communication for the super frame has been finished. If the communication for the super frame is not finished, the procedure returns to step 609, and thus communication for a next 5 msec frame is resumed. Otherwise, the procedure returns to step 601, and the subsequent steps are repeated to resume the communication for the next super frame.

According to exemplary embodiments of the present invention, for a service (e.g., VoIP service) in which resources are periodically allocated, resource allocation information is transmitted during each main period (i.e., super frame), and thus there is an advantage in that the size of control information can be significantly reduced. In addition, since updated resources are transmitted during each sub period (i.e., 5 msec frame), there is an advantage in that waste of resource can be reduced, which may occur when a call (or service) is released.

While the invention has been shown and described with reference to certain exemplary embodiments thereof, it will be understood by those skilled in the art that various changes in form and details may be made therein without departing from the spirit and scope of the invention as defined by the appended claims and their equivalents. For example, the messages described in Table 1 and Table 2 are an exemplary purpose only, and thus the messages may have various forms within the scope of the invention. Therefore, the scope of the invention is defined not by the detailed description of the invention but by the appended claims and their equivalents, and all differences within the scope will be construed as being included in the present invention.

What is claimed is:

1. An apparatus for transmitting and receiving a super frame including one or more sub-frames in a Broadband Wireless Access (BWA) system, the apparatus comprising:
a first generator for generating resource allocation information on a circuit service; and
a transmitter for transmitting the resource allocation information provided from the first generator in a first part of the super frame.

2. The apparatus of claim 1, further comprising a second generator for generating resource allocation information on a changed resource when the resource for the circuit service is changed in the current sub-frame, wherein the transmitter transmits the resource allocation information provided from the second generator via a control region of the current sub-frame.

3. The apparatus of claim 1, wherein the sub-frame has a length of 5 msec.

4. The apparatus of claim 1, wherein the first part of the super frame comprises at least one region selected from a group consisting of a first region for transmitting a preamble signal, a second region for transmitting system parameter information and a third region for transmitting resource allocation information on the circuit service.

5. The apparatus of claim 1, wherein the resource allocation information comprises at least one item selected from a group consisting of a resource allocation period, the number of users, a user ID, a Modulation and Coding Scheme (MCS) level and resource allocation information.

6. The apparatus of claim 2, wherein the resource allocation information on the changed resource comprises at least one item selected from a group consisting of information on a resource to be deleted in the current sub-frame, information on a resource to be updated in the current sub-frame and information on a resource to be added in the current sub-frame.

7. The apparatus of claim 1, wherein the circuit service comprises a Voice over Internet Protocol (VoIP) service.

8. An apparatus for transmitting and receiving a super frame including one or more sub-frames in a Broadband Wireless Access (BWA) system, the apparatus comprising:
a receiver for restoring a signal, received from a base station, into a packet; and
a first analyzer for analyzing the packet received from a first part of the super frame so as to obtain resource allocation information on a circuit service.

9. The apparatus of claim 8, further comprising a second analyzer for obtaining relative resource allocation information indicating resource change information for the circuit service by analyzing a packet received via a control region of the sub-frame.

10. The apparatus of claim 8, wherein the sub-frame has a length of 5 msec.

11. The apparatus of claim 8, wherein the first part of the super frame comprises at least one region selected from a group consisting of a first region for transmitting a preamble signal, a second region for transmitting system parameter information and a third region for transmitting resource allocation information on the circuit service.

12. The apparatus of claim 8, wherein the resource allocation information comprises at least one item selected from a group consisting of a resource allocation period, the number of users, a user ID, a Modulation and Coding Scheme (MCS) level and resource allocation information.

13. The apparatus of claim 9, wherein the relative resource allocation information on the updated resource comprises at least one item selected from a group consisting of information on a resource to be deleted in the current sub-frame, information on a resource to be updated in the current sub-frame and information on a resource to be added in the current sub-frame.

14. The apparatus of claim 8, wherein the circuit service comprises a Voice over Internet Protocol (VoIP) service.

15. A method for transmitting and receiving a super frame including one or more sub-frames in a base station of a Broadband Wireless Access (BWA) system, the method comprising:
generating resource allocation information on a circuit service; and
transmitting the resource allocation information provided from the first generator in a first part of the super frame.

16. The method of claim 15, further comprising:
generating relative resource allocation information on an changed resource when the resource for the circuit service is changed in the current sub-frame; and
transmitting the relative resource allocation information via a control region of the current sub-frame.

17. The method of claim 15, wherein the sub-frame has a length of 5 msec.

18. The method of claim 15, wherein the first part of the super frame comprises at least one region selected from a group consisting of a first region for transmitting a preamble signal, a second region for transmitting system parameter information and a third region for transmitting resource allocation information on the circuit service.

19. The method of claim 15, wherein the resource allocation information comprises at least one item selected from a group consisting of a resource allocation period, the number of users, a user ID, a Modulation and Coding Scheme (MCS) level and resource allocation information.

20. The method of claim 16, wherein the relative resource allocation information on the changed resource comprises at least one item selected from a group consisting of information on a resource to be deleted in the current sub-frame, information on a resource to be updated in the current sub-frame and information on a resource to be added in the current sub-frame.

21. The method of claim 15, wherein the circuit service comprises a Voice over Internet Protocol (VoIP) service.

22. A method for transmitting and receiving a super frame including one or more sub-frames in a mobile station of a Broadband Wireless Access (BWA) system, the method comprising:
restoring a signal, received from a base station, into a packet; and
analyzing the packet received from a first part of the super frame so as to obtain resource allocation information on a circuit service.

23. The method of claim 22, further comprising obtaining relative resource allocation information indicating resource change information for the circuit service by analyzing a packet received via a control region of the sub-frame.

24. The method of claim 22, wherein the sub-frame has a length of 5 msec.

25. The method of claim 22, wherein the first part of the super frame comprises at least one region selected from a group consisting of a first region for transmitting a preamble signal, a second region for transmitting system parameter information and a third region for transmitting resource allocation information on the circuit service.

26. The method of claim 22, wherein the resource allocation information comprises at least one item selected from a group consisting of a resource allocation period, the number of users, a user ID, a Modulation and Coding Scheme (MCS) level and resource allocation information.

27. The method of claim 23, wherein the relative resource allocation information on the updated resource comprises at least one item selected from a group consisting of information on a resource to be deleted in the current sub-frame, information on a resource to be updated in the current sub-frame and information on a resource to be added in the current sub-frame.

28. The method of claim 22, wherein the circuit service comprises a Voice over Internet Protocol (VoIP) service.

29. A method for transmitting and receiving a super frame including one or more sub-frames in a wireless communication system, the method comprising:
constructing a control region for transmitting resource allocation information on a circuit service in a first part of the super frame; and
if a resource for the circuit service has been changed, constructing a region for transmitting relative resource allocation information on the changed resource in a corresponding sub-frame.

30. The method of claim 29, wherein the first part of the super frame comprises at least one region selected from a group consisting of a first region for transmitting a preamble signal, a second region for transmitting system parameter information and a third region for transmitting resource allocation information on the circuit service.

31. The method of claim 29, wherein the resource allocation information on the circuit service is valid for the super frame period.

32. The method of claim 29, wherein the resource allocation information for the circuit service comprises at least one item selected from a group consisting of a resource allocation period, the number of users, a user ID a Modulation and Coding Scheme (MCS) level, and resource allocation information.

33. The method of claim 29, wherein the relative resource allocation information is valid for the corresponding sub-frame period.

34. The method of claim 29, wherein the relative resource allocation information comprises at least one item selected from a group consisting of information on a resource to be deleted in the corresponding sub-frame, information on a resource to be updated in the corresponding sub-frame and information on a resource to be added in the corresponding sub-frame.
